(19) United States
(12) Patent Application Publication
(10) Pub. No.: US 2025/0170943 A1
(43) Pub. Date: May 29, 2025

(54) VEHICLE STORAGE AND LOADING SYSTEM

(71) Applicant: Nader Hachem, West Bloomfield, MI (US)

(72) Inventor: Nader Hachem, West Bloomfield, MI (US)

(21) Appl. No.: 18/960,602

(22) Filed: Nov. 26, 2024

Related U.S. Application Data
(60) Provisional application No. 63/603,739, filed on Nov. 29, 2023.

(51) Int. Cl. B60P 1/32; B60R 9/06; B60R 9/08

(52) U.S. Cl. CPC B60P 1/32; B60R 9/06; B60R 9/08

(57) ABSTRACT

A vehicle storage and loading system functions to load and unload an object or objects into and out of a vehicle cargo area, such as a trunk or truck bed, while also functioning to secure the object or objects during transport. A base frame rests in a vehicle cargo area and has sliding supports that move between a stored position and an extended position relative the vehicle cargo area. A cradle is supported by the sliding supports and holds an object, such as sporting or camping equipment. A loading hinge is attached between the cradle and the sliding supports. With the sliding supports in the extended position, the cradle pivots about the loading hinge from a holding position that is relatively flat or horizontal to a loading position that is upright or angled relative the holding position.

### CROSS-REFERENCE TO RELATED APPLICATION

This application claims benefit and priority under 35 U.S.C § 119(e) to U.S. Provisional Patent Application No. 63/603,739, filed Nov. 29, 2023, the disclosure of which is considered part of this application and is hereby incorporated by reference in its entirety.

### TECHNICAL FIELD

The present disclosure relates generally to a system for storing, loading, and unloading an object in the of a vehicle, such as a large or heavy object, like a golf bag, a hockey bag, a ski bag, a snowboard bag, a canopy or tent, or another container or object.

### BACKGROUND

Oftentimes, recreational activities, such as sports and camping, involve loading and unloading large and heavy equipment into and out of a vehicle that is used to transport the equipment. In some cases, the weight and bulk of the equipment is difficult for an individual to lift into or out of the vehicle, making this loading and unloading process a deterrent to participating in and enjoying the recreational activities. Also, once the equipment is loaded into the vehicle, such as a trunk, a cargo area, or a cargo bed of a truck or van, the equipment may be subject to sliding, rolling, or other undesirable movement that can damage the equipment and vehicle, as well as being a distraction to the driver. It would be beneficial to provide a storage and loading system that would allow a user to more easily load this equipment into and out of the vehicle. It would be additionally beneficial to provide a system that secures the equipment and the vehicle during transport.

### SUMMARY

This disclosure provides a vehicle storage and loading system that functions to load and unload an object or objects into and out of a vehicle cargo area, such as a trunk or truck bed, while also functioning to secure the object or objects during transport. The vehicle storage and loading system includes a base frame that is configured to rest in a vehicle cargo area. A sliding support is coupled to the base frame and is configured to move between a stored position and an extended position relative the vehicle cargo area. The system also includes a cradle that is supported by the sliding support and is configured to hold an object, such as sporting or camping equipment. A loading hinge is attached between the cradle and the sliding support. With the sliding support in the extended position, the cradle is configured to pivot about the loading hinge between a holding position that is relatively flat or horizontal and a loading position that is upright or angled relative the holding position.

In some implementations, the sliding support may include an elongated beam that is at least partially disposed between the base frame and the cradle. Also, in some examples, a slide mechanism may be at least partially disposed between the base frame and the sliding support, where the sliding support slidably moves on the slide mechanism from the stored position to the extended position. The sliding support may be vertically aligned with the base frame in the stored position, such that the sliding support is vertically offset from the base frame in the extended position.

In some examples, a first slide mechanism may be disposed between the base frame and the sliding support and a second slide mechanism may be disposed between the sliding support and the cradle. In this arrangement, the sliding support may slidably move on the first slide mechanism from the stored position to the extended position, and the cradle may slidably move on the second slide support from a second stored position to a second extended position with the cradle at least partially extending out of a rear end of the vehicle cargo area.

Also, in some examples, a slide mechanism may be at least partially disposed between the sliding support and the cradle, where the cradle slidably moves on the slide mechanism between a second stored position and a second extended position. The cradle may be vertically aligned with the sliding support in the second stored position and the cradle may be vertically offset from the sliding support in the second extended position.

Further, in some implementations, the sliding support may be slidably coupled to an intermediate frame that is coupled to the base frame via a tipping hinge. In the loading position, the tipping hinge may be configured to pivot the intermediate frame upward from the base frame.

In some examples, a folding arm may be coupled to the base frame and configured to attach to a connection feature on a sidewall of the vehicle cargo area. The folding arm may include a stow hinge that is configured, with the sliding support in the stored position, to pivot the base frame about the stow hinge to a folded position adjacent to the side wall of the vehicle cargo area. The folding arm, in some examples, includes a first section coupled to the base frame and a second section extending perpendicular to the first section to attach to the connection feature.

In some implementations, the cradle may include a tray that has a contoured surface configured to hold the object and may include side walls that extend at least partially over the sliding support in the stored position. The cradle may also include a rigid platform that extends from a bottom portion of the tray to support the object with the cradle angled or upright in the loading position. Further, the cradle may include one or more straps extending across the contoured surface between opposing sides of the tray to retain the object in the cradle.

Another aspect of the disclosure provides a vehicle storage and loading system that includes a base frame and a pair of sliding supports that are slidably coupled to the base frame, such that the sliding supports are configured to slide between a stored position and an extended position relative the base frame. The system also includes a cradle that is supported by the pair of sliding supports and is configured to hold an object, such as sporting or camping equipment. A pair of loading hinges is attached between the cradle and the pair of sliding supports. With the pair of sliding supports in the extended position, the cradle is configured to pivot about the pair of loading hinges between a holding position that is substantially parallel with the base frame and a loading position that is angled relative the base frame.

In some implementations, the pair of sliding supports may be slidably coupled between the base frame and the cradle. For example, the sliding supports may be slidably supported on the base frame with a first set of slides and the cradle may be slidably supported on the sliding supports with a second set of slides. In some examples, the cradle is slidably coupled to the pair of sliding supports, where the cradle may slide from an intermediate stored position to a second extended position relative to the pair of sliding supports. With the pair of sliding supports in the extended position and the cradle in the intermediate stored position, the cradle may be moved a first distance relative to the base frame, and with the pair of sliding supports in the extended position and the cradle in the second extending position, the cradle may be moved a second distance relative to the base frame that is greater than the first distance.

The cradle, in some implementations, may include a tray having a contoured surface configured to hold the object. Also, the tray may have side walls that extend at least partially over the pair of sliding supports in the stored position. In some examples, the tray may include a rigid platform that extends from a bottom portion of the tray to support the object with the cradle angled or upright in the loading position. Also, in some examples, the cradle may include one or more straps extending across the contoured surface between opposing sides of the tray to retain the object in the cradle.

In some examples, a folding arm may be coupled to the base frame and configured to attach to a connection feature of a vehicle cargo area. The folding arm may include a stow hinge that is configured, with the pair of sliding supports in the stored position, to pivot the base frame, the pair of sliding supports, and the cradle about the stow hinge to a stowed position.

In some implementations, the pair of sliding support may be coupled to an intermediate frame. The intermediate frame may be coupled to the base frame via a pair of tipping hinges. The tipping hinges may be attached to a bottom edge of the intermediate frame and to a bottom edge of the first and second longitudinal supports of the base frame. As the cradle is moved to the loading position, the tipping hinges may pivot the intermediate frame and sliding supports upward from the base frame.

Yet another aspect of the disclosure provides a storage and loading assembly for a vehicle cargo area, such as a trunk or truck bed. The assembly includes a base frame and cradle that is slidably supported on the base frame. The assembly may also include a two-stage slide mechanism attached between the base frame and the cradle, where the two-stage slide mechanism is configured to slide the cradle from a stored position to an intermediate extended position at a first stage of sliding and to an extended position at a second stage of sliding. The assembly also includes a loading hinge that is attach between the cradle and the two-stage slide mechanism to pivot the cradle relative to the base frame when in the extended position, such as in an angled orientation for loading the object onto or unloading the object from the cradle. In some examples, the two-stage slide mechanism includes a first slide mechanism may be disposed between the base frame and a sliding support and a second slide mechanism may be disposed between the sliding support and the cradle. In this arrangement, the sliding support may slidably move on the first slide mechanism from the stored position to the intermediate position, and the cradle may slidably move on the second slide support from the intermediate position to the extended position, such as with the cradle at least partially extending out of a rear end of the vehicle cargo area. In other examples, more or fewer slide mechanisms may be provided.

Each of the above independent aspects of the present disclosure, and those aspects described in the detailed description below, may include any of the features, options, and possibilities set out in the present disclosure and figures, including those under the other independent aspects, and may also include any combination of any of the features, options, and possibilities set out in the present disclosure and figures.

The details of one or more implementations of the disclosure are set forth in the accompanying drawings and the description below. Other aspects, advantages, purposes, and features will be apparent upon review of the following specification in conjunction with the drawings.

### BRIEF DESCRIPTION OF THE DRAWINGS

FIG. 1 is a perspective view of a vehicle having a storage and loading system.

FIG. 2 is a perspective view of the storage and loading system in a stored position.

FIG. 2A is a cutaway perspective view of the storage and loading system of FIG. 2, showing the frame with the tray and supported golf bag removed.

FIG. 3 is a perspective view of the storage and loading system in an intermediate position.

FIG. 3A is a cutaway perspective view of the storage and loading system of FIG. 3, showing the frame with the tray and supported golf bag removed.

FIG. 4 is a perspective view of the storage and loading system in an extended position.

FIG. 4A is a cutaway perspective view of the storage and loading system of FIG. 4, showing the frame with the tray and supported golf bag removed.

FIG. 5 is a perspective view of the storage and loading system in a loading position.

FIG. 5A is a cutaway perspective view of the storage and loading system of FIG. 5, showing the frame with the tray and supported golf bag removed.

FIG. 6 is a perspective view of the storage and loading system in the loading position.

FIG. 6A is a side view of the storage and loading system of FIG. 6, showing the frame with the tray in dashed lines.

FIG. 7 is a perspective view of the storage and loading system in the folded position.

FIG. 7A is an end view of the storage and loading system of FIG. 7.

FIG. 8 is an exploded view of the storage and loading system of FIG. 2.

FIG. 9 is a transverse cross-sectional view of the storage and loading system of FIG. 2 taken along line IX-IX.

FIG. 10 is an enlarged view of a portion of the storage and loading system of FIG. 9 taken in area X.

Like reference numerals indicate like parts throughout the drawings.

### DETAILED DESCRIPTION

A vehicle storage and loading system and assembly for use with an object or objects, such as recreational gear or other equipment or containers, that are loaded in and out of a vehicle cargo area, such as a rear cargo area of a passenger vehicle, is disclosed herein in various implementations. The system and assembly may include a movable support structure designed for securely holding one more objects, which is referred to herein as a cradle. The cradle can be positioned to receive the object, in a generally upright orientation outside of the vehicle cargo area. Once the object is loaded into the cradle, the cradle can be pivoted from the loading position to a flat or horizontal orientation and slid into the vehicle's cargo area, such as a vehicle's trunk, cargo floor, or truck bed. To effectuate this movement into the cargo area, the cradle is supported by a base frame that employs hinges and slides. With the object supported on the cradle in a stored position, the cradle may also function to secure the object in place within the vehicle cargo area while in transit to prevent potential damage and undesired movement of the bag. The system may likewise be used during unloading of supported object to easily slide the cradle out of the cargo area and to pivot the cradle down to position the object in a generally upright orientation. Further, in some examples, the system or assembly may include an stow hinge attached to the vehicle storage area, such as a tiedown on the sidewall, where the stow hinge can function to fold the base frame and cradle from a holding position to a stowed or folded position in the cargo area, such as to store the empty cradle adjacent to or against the sidewall of the vehicle cargo area when not in use.

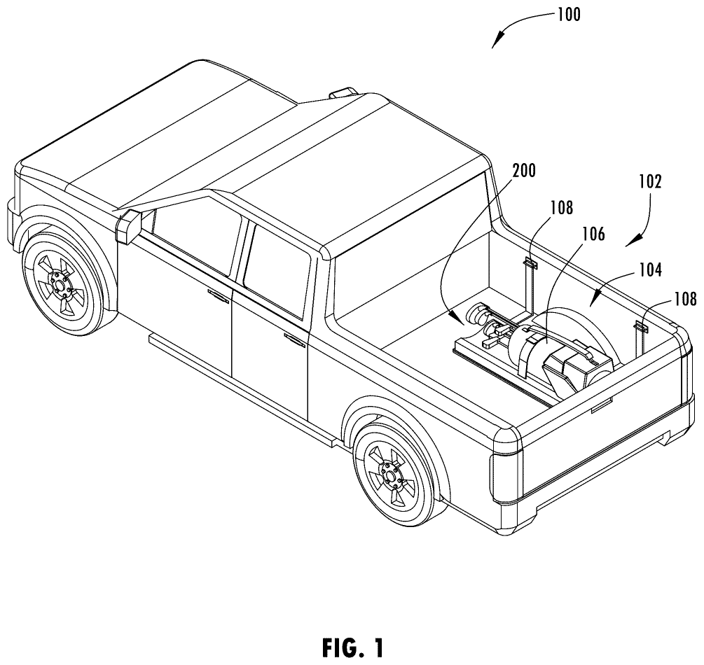

Referring to FIG. 1, a vehicle 100 is shown having a cargo area embodied as a truck bed area 102 that is generally bound by the floor, the bulkhead, sidewalls, and the movable tailgate. The vehicle 100 may, in other examples, be a vehicle with an alternative cargo area, such as a van floor, an SUV cargo floor, an enclosed trunk area, or the like. A storage and loading system 104 is shown in a stored position 200 with a golf bag 106 loaded in and retained by the system 104. The system 104 is secured to the truck bed 102 at a pair of truck tie downs 108. The system 104 thereby retains the golf bag 106 relative to the truck bed 102, such that in transport, the golf bag 106 is restricted from undesired movement. Additionally, connection to the tie downs 108 prevents the system 104 from moving within the truck bed 102, in both an empty state and a state of being loaded with a golf bag. Alternatively, the system 104 could be stored in a cargo area, such as a trunk or van cargo floor, without tie downs. The floor of the cargo area may also have a surface with a coefficient of friction, such as a rubber coating, spray coating, or carpet, or a surface structure, such as a ribbed plastic or the like, that interfaces with the system 104 to prevent movement of the system 104 relative to the cargo area.

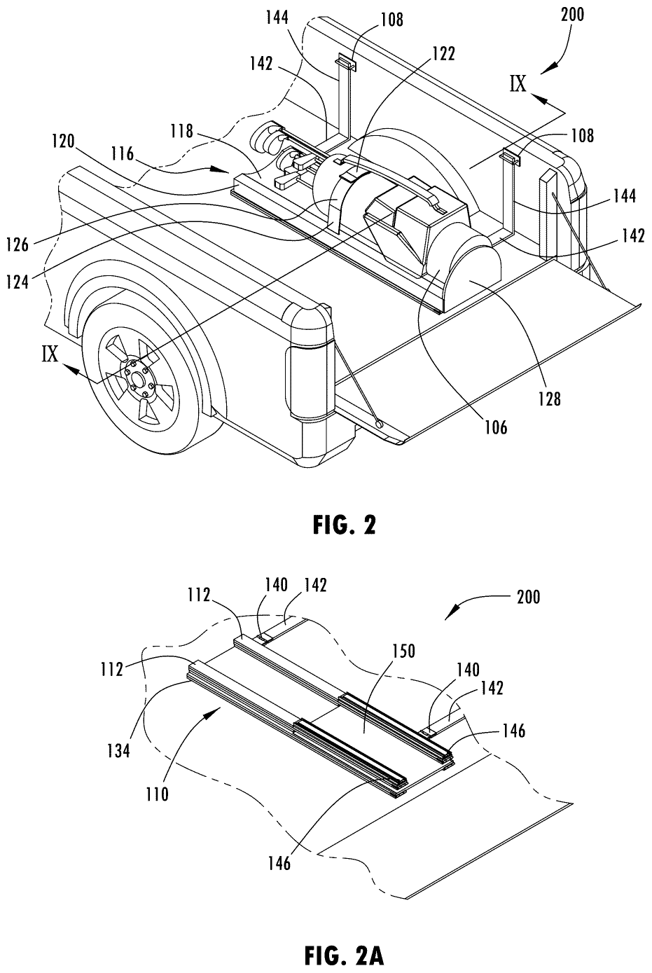

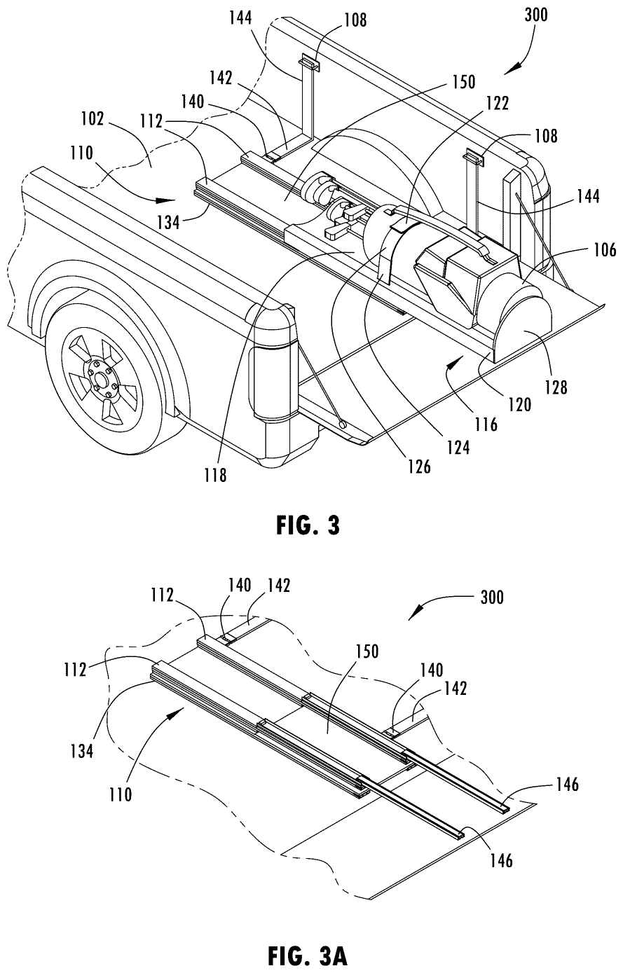

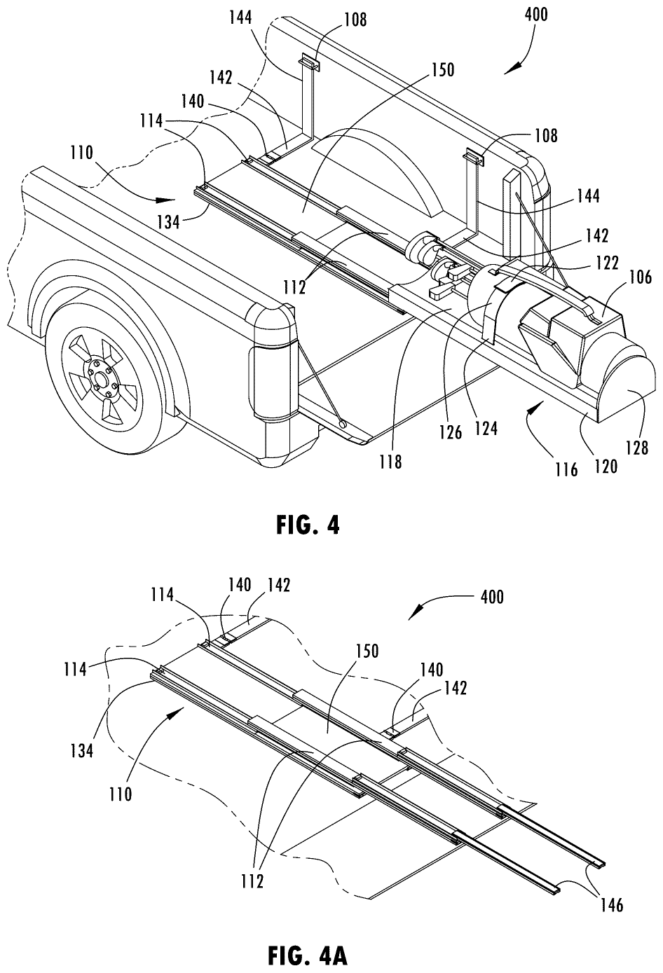

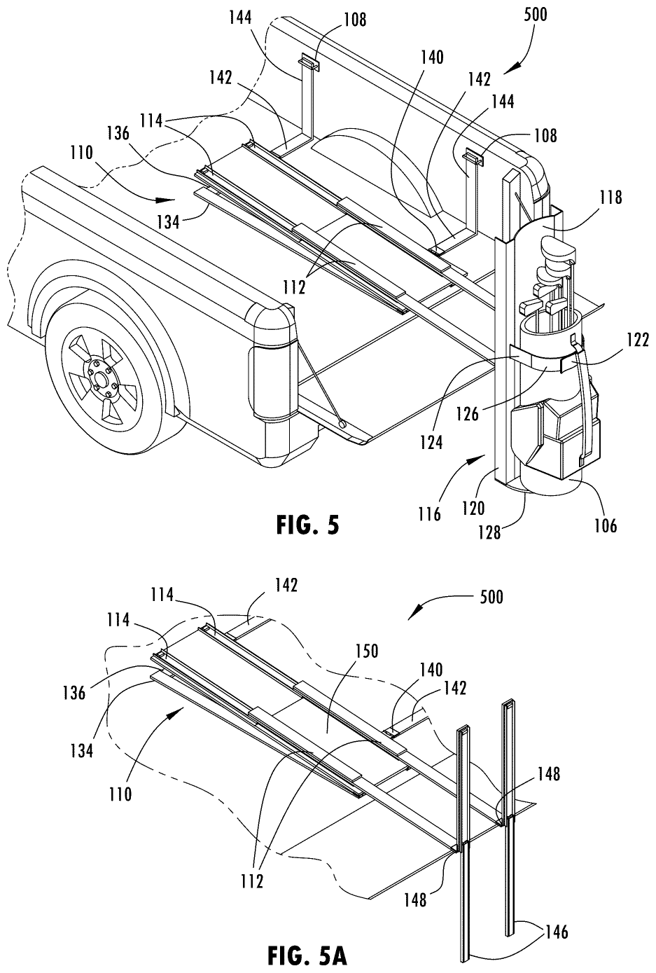

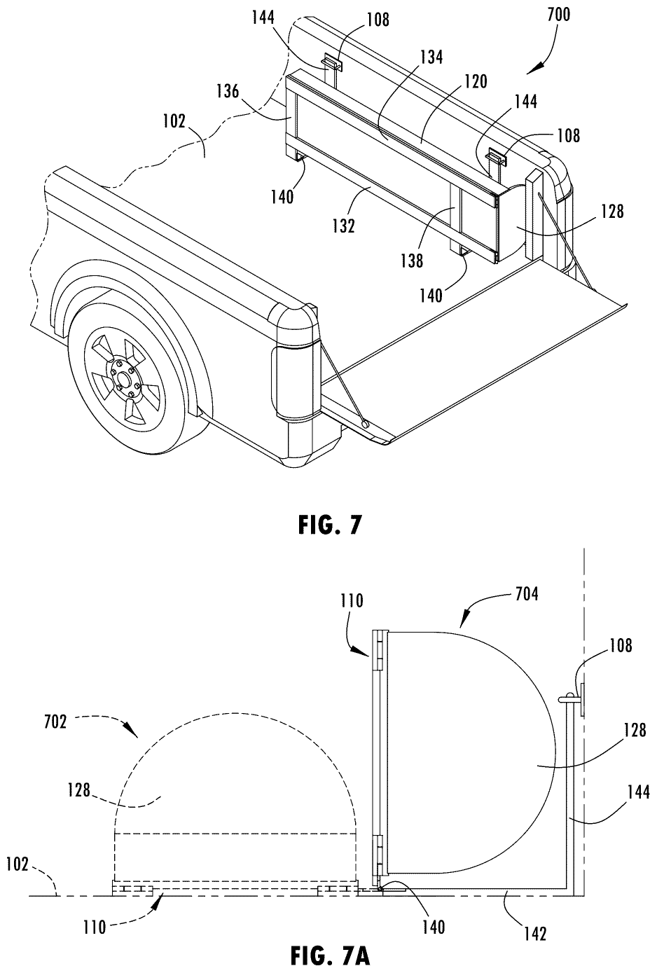

Referring to FIGS. 2-5A, the system 104 is movable between various positions. FIGS. 2 and 2A illustrate the system 104 in a stored position 200. FIGS. 3 and 3A illustrate the system 104 in an intermediate position 300 between the stored position 200 and the extended position 400. FIGS. 4 and 4A illustrate the system in an extended position 400. FIGS. 5 and 5A illustrate the system in a loading position 500. A user engages the system in the various positions as the user manually moves the system 104 in and out of a cargo area to load and/or unload a golf bag from the system. When the system 104 is not in use, the system 104 may be placed in a folded position 700 as illustrated in FIGS. 7 and 7A. A user may move the system 104 to the folded position 700 to position the frame 110 and to cradle 116 the side of the cargo area, such as against the sidewall of a truck bed 102, so as to be out of the way to allow the cargo bed to be available for other uses. The positions are described in further detail below.

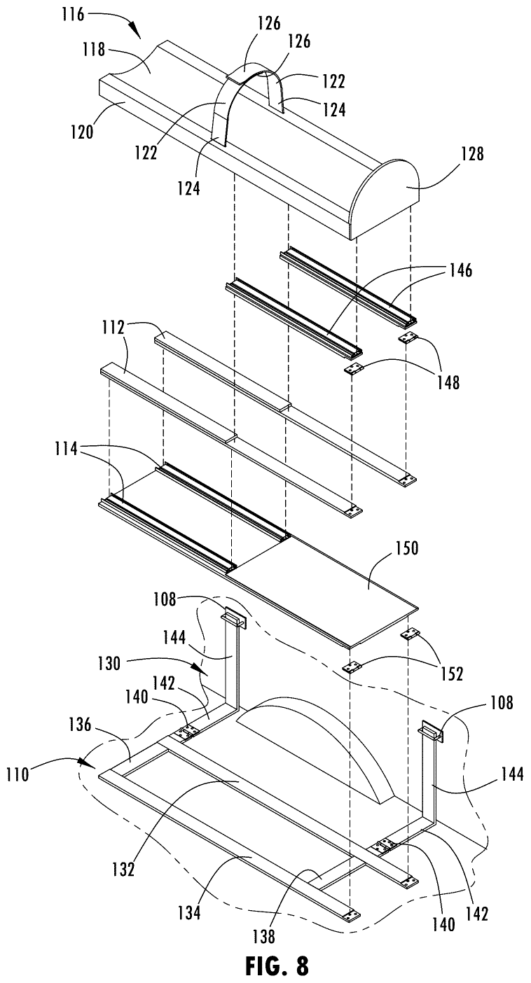

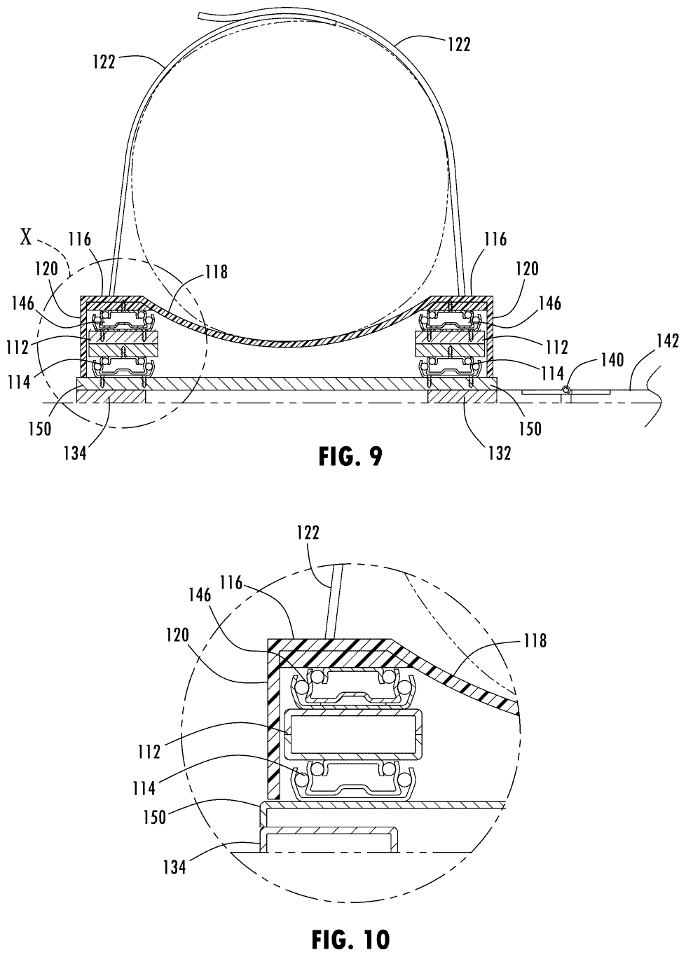

Referring to FIGS. 2 and 2A, the system 104 is shown in the stored position 200. In the stored position, the golf bag 106 has been loaded and secured in the system 104 and is positioned fully in the truck bed area 102. The system 104 includes a base frame 110, which in the stored position 200, lays generally horizontal and parallel to the surface of the truck bed 102. The base frame 110 may have a generally rectangular shape, such as shown for example in FIGS. 8 and 9 having an upper support 136, a lower support 138, a first longitudinal support 132, and a second longitudinal support 134. The first longitudinal support 132 may extend between a first side of the upper support 136 and a first side of the lower support 136. The second longitudinal support 134 may extend between a second side of the upper support 136 and a second side of the lower support. In additional examples, the base frame may be differently constructed or shaped, such as one or more panel structures.

In the example shown in FIG. 2A, in the stored position 200, the sliding supports 112 are positioned such that they are vertically aligned with the base frame 110, or in other words positioned fully within the cargo area and over the base frame 100. In particular, the sliding supports 112 in the stored position are aligned with the first longitudinal support 132 and the second longitudinal support 134 of the base frame 100. The sliding supports 112 are configured to move from the stored position 200 (i.e., vertically aligned with the base frame 110) toward and to an extended position (i.e., vertically offset from the base frame 110) (FIGS. 4 and 5). As shown, the sliding supports 112 each include an elongated beam that may be formed of metal, wood, polymer, or a composite material. The sliding supports 112 slide via a set of slides or side mechanisms 114, such that a first slide component of the pair slides 114 engages with a first slide component of the pair of sliding supports 112 and a second slide component of the set of slides 114 engages with a second slide component of the pair of sliding supports 112 (FIG. 8). The engaged slide components are configured to longitudinally slide relative to each other via ball bearings, such as in a drawer slide, vehicle seat slider, or the like. In additional examples alternative types of the slide components may be used to provide the sliding movement.

The system 104 also includes a cradle 116 for holding an object, which as shown is a golf bag 106. The cradle 116 may include a tray 118 having a concave surface configured to hold the golf bag 106. The tray may also be referred to as a cradle or a rack. The cradle 116 may have two side walls 120, such as shown for example in FIG. 9, where a first side wall integrally extends from a first longitudinal side of the tray 118 and a second side wall integrally extends from a second longitudinal side of the tray 118. The side walls 120 extend over and cover the base frame 110 in the stored position 200, as shown in FIG. 2. In particular, the side wall 120 extends down over the sliding supports 112 and the slides 114 (FIG. 10). The tray 118 may include a bottom extension 128, such as shown in FIG. 2, protruding from a bottom edge of the tray 118. The bottom extension 128 has a curved shape, shown as a half circle shape for supporting a bottom of the golf bag 106. The bottom extension 128 provides a rigid platform to support the golf bag 106 in the upright orientation, as well as provides a structure for a user to grasp as they pull or push the cradle 116 between the stored position and the extended position. In some examples, the bottom extension may include a hinge to allow it to fold or collapse toward the tray, such as when not in use or when folded to a stowed position.

As shown in FIG. 2, the cradle 116 includes straps 122 that over the golf bag 106 to secure the bag 106 to the tray 118. For example, the cradle 116 may include a pair of straps 122 that extends from opposing sides of the tray 118 and attach together over the golf bag. The first strap extends from the surface of the tray 118 approximate the first longitudinal wall of the tray 118 and the second strap extends from the surface of the tray 118 approximate the second longitudinal wall of the tray 118. Each of the straps 122 may be configured to extend around the surface of the golf bag 106, such as through a handle of the bag 106, to engage the other strap. The pair of straps 122 may each have a first section 124 extending from the cradle 116 and a second section 126 extending from the first section 124 that engages the other strap, for example via hook and loop, buckle, button snap connection, or the like. The first section 124 and the second section 126 are comprised of two different materials. For example, the first section 124 may comprise of a stiffer plastic that provides rigidity to the structure supporting and holding the bag 106 in place. The second section 126 may comprise of a flexible material such as a fabric with hook and loop to extend around the golf bag 106 and connect with the other strap. Alternatively, in other examples, the first section of the strap and the second section of the strap may be formed of the same material.

The base frame 110, such as shown in FIG. 8, includes a pair of arms 130 that secure the frame 110 to the vehicle 100, and in particular, to the pair of tie downs 108. In additional examples, the arms may connect to other features on the sidewall of the cargo area or may be fastened to the sidewall where no structural features are present or accessible As shown, the frame 110 may include one arm of the pair of arms 130 extending from the first longitudinal support 132 of the frame 110 approximate the upper support 136 (FIG. 8). The frame 110 may include the other arm of the pair of arms 130 extending from the first longitudinal support 134 of the frame 110 approximate the lower support 138. In additional examples, more or fewer arms may be used and in some examples the arms may be attached to the frame at different locations, such as to accommodate different tie down locations in different types of vehicles.

As further shown in FIG. 8, the arms 130 are each coupled to the first longitudinal support 132 via a stow hinge 140. The pair of arms 130 may each include a first portion 142 and a second portion 144. The first portion 142 may extend from the stow hinge 140 in a position generally aligned with the respective upper or lower support 136, 138 of the frame 110. The second portion 144 may extend vertically from the first portion 142 at an end opposite the stow hinge 140, such that the second portion 144 is perpendicular to the first portion 142. The second portion 144 may be coupled to the tie down 108, for example via a hook, strap, or other securing means. The first portion 142 and the second portion 144 are configured to lie generally flat against the cargo bed floor and side surface, shown as a truck bed surface and the truck sidewall surface, respectively. The stow hinges 140 are configured to fold the base frame 110 approximately 90 degrees from a position parallel to the truck bed bottom surface to a position parallel to the truck bed side surface (FIG. 7), such that a user may fold the frame 110 out of the way when not in use. In other words, the stow hinges 140 are configured to fold the system 104 from the stored position 200 to the stowed or folded position 700 when the system 104 is not being used to store a golf bag 106.

Referring to FIGS. 3 and 3A, an intermediate position 300 is illustrated between the stored position 200 and the extended position 400. In the stored position 200, the pair of sliding supports 112 and the cradle 116 are both vertically aligned with the base frame 110 (FIG. 2). In the extended position 400, the sliding supports 112 and the cradle 116 are both vertically offset from the base frame 110, and vertically offset from each other (FIG. 4). In the intermediate position 300, the sliding supports 112 remain vertically aligned with the base frame 110, with the cradle 116 in a position vertically offset with the frame 110. The cradle 116 may be coupled to the pair of sliding supports 112 via a second set of slides 146 configured to slide the cradle 116 forward to a position such that it is vertically offset from the sliding supports 112. As a user pulls on the cradle 116 to extend the cradle 116 out of a truck bed 102, the second set of slides 146 is engaged prior to the first set of slides 114, such that the cradle 116 moves to the intermediate position 300 with the second set of slides 146 extended.

Referring to FIGS. 4 and 4A, the extended position 400 is illustrated after the cradle 116 and the pair of sliding supports 112 have been pulled forward to or near their extended limit. In the extended position 400, the sliding supports 112 and the cradle 116 are both vertically offset from the base frame 110. Additionally, the sliding supports 112 and the cradle 116 are vertically offset from each other, with the cradle 116 pulled forward further than the sliding supports 112. With the second set of slides 146 and the cradle 116 pulled forward from the sliding supports 112 (i.e., the intermediate position 300), the first set of slides 114 pulls the pair of sliding supports 112 forward from their position above the base frame 110. With the first set of slides 114 and the second set of slides 146 extended, the system 104 is in or near its fully extended position 400. In the extended position 400, the cradle 116 may extend outside of the truck bed area 102.

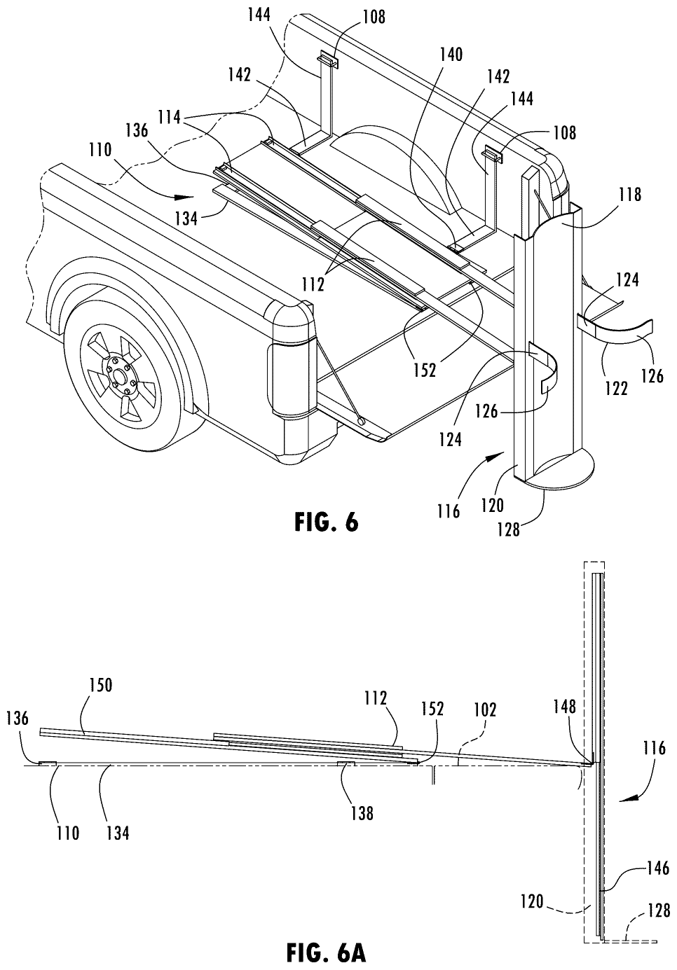

Referring to FIGS. 5-6A, the cradle 116 is illustrated in the loading position 500 after the system 104 has been moved into the extended position 400 and the cradle 116 is pivoted about the loading hinges 148 to an upright orientation. The cradle 116 is coupled to each of the pair of sliding supports 112 via a loading hinge 148. The loading hinges 148 are configured to pivot the cradle 116 at a bottom edge of the sliding supports 112, such that the cradle 116 may move to a standing position that is angled relative to the sliding supports and truck bed, such as shown generally perpendicular to the base frame 110 and sliding supports 112. In the extended position, a user may stand the cradle 116 upward such that the bottom surface 128 of the cradle 116 may be positioned approximate the ground and the golf bag 106 can be loaded or unloaded with ease as a user no longer needs to lift the bag 106 fully into a trunk bed.

Referring to FIGS. 6 and 6A, the frame 110 may include an intermediate frame 150 between the base frame 110 and the sliding supports 112. The intermediate frame 150 may comprise of a generally rectangular frame having the first set of slides 114 on a top surface of the frame 150. The intermediate frame 150 may be coupled to the base frame 110 via a set of tipping hinges 152 attached to a bottom edge of the intermediate frame 150 and at a bottom edge of the first longitudinal support 132 and the second longitudinal support 134 of the base frame 110. The tipping hinges 152 may provide a slight lift to the top edge of the intermediate frame 150 and the sliding supports 112 to reduce tension to the base frame 110 as the cradle 116 is moved into the standing position 500. For example, as the cradle 116 is moved into the standing position 500, the base frame 110 may remain flat against the truck bed surface 102 to maintain stability of the system 104. The intermediate frame 150 pivots upward at the end opposite the tipping hinges 152 to reduce force on the base frame 110 as the cradle 116 is being loaded or unloaded. The tipping hinges 152 may allow the intermediate frame 150 to pivot in the range of approximately less than 10 degrees from plane, or in preferred examples, in the range of approximately 5 degrees from the plane of the truck bed 102.

Referring to FIGS. 7 and 7A, the folded position 700 is illustrated. The folded position 700 may be engaged when the system 104 is not in use and a user would like to store the system 104 against a truck bed side surface to use the truck bed bottom surface for other uses. For example, when the system 104 is in the stored position 200 and is not storing a golf bag 106, the system 104 is configured to move to the folded position 700 via the pair of hinge 140. In particular, in the stored position 200, the upper support 136 of the base frame 110 is horizontally aligned with the first portion 142 of the upper of the pair of arms 130 and the lower support 138 of the base frame 110 is horizontally aligned with the first portion 142 of the lower of the pair of arms 130. The hinges 140 may be engaged to pivot the base frame 110 to the folded position 700 where the upper support 136 of the base frame 110 is perpendicular to the first portion 142 of the upper of the pair of arms 130 and the lower support 138 of the base frame 110 is perpendicular to the first portion 142 of the lower of the pair of arms 130. The bottom surface 128 of the cradle 116 extends towards the truck bed side surface. The bottom surface 128 protrudes from the cradle 128 a distance less than the length of the first portion 142 of the arms 130 such that the bottom surface 128 does not prevent the system 104 from being folded toward the truck bed side surface.

Referring to FIG. 8, an exploded view of the system 104 is illustrated in the stored position 200. As illustrated and as described above with regard to at least FIG. 2, in the stored position 200, the cradle 116 is vertically aligned with the pair of sliding supports 112 and the base frame 110, and in particular, the first longitudinal support 132 and the second longitudinal support 134 of the base frame 110. The first and second longitudinal supports 132, 134 are coupled to the intermediate frame 150 via respective tipping hinges 152. In alternate configurations, the sliding supports may be directly coupled to the base frame in the absence of an intermediate frame. The first set of slides 114 are coupled to the intermediate frame 150 and configured to engage the respective sliding supports 112. In alternate configurations, the first pair of drawers slides 114 may be coupled directly to the base frame along the first and second longitudinal walls. The pair of sliding supports 112 are coupled to the cradle 116 via respective loading hinges 148. Additionally, the second set of slides 146 are coupled to the respective sliding supports 112 and coupled to engage the cradle 116.

Referring to FIGS. 9 and 10, a cross-sectional view of the of the system 104 along line IX-IX illustrated in FIG. 2 is shown. As illustrated, the system 104 includes a cradle 106 that has the tray 118 with a contoured surface for holding and directly interfacing with the object. The contoured surface may be configured to correspond to the commonly held object, such as shown with a concave surface that corresponds to the shape of a traditional golf bag and generally prevents lateral movement of the golf bag relative to the cradle. The contoured surface may include other shapes or features that assist with mating to the shape of the object, such as fabric or foam material covering portions of the surface that may prevent damage, such as marring or scratching of heads of the golf clubs, or may prevent noise, such as rattling caused by heads of the golf clubs. The cradle 106 may include side walls 120 which extend downward from longitudinal edges of the tray 118. The side walls 120 extend over the sliding mechanisms to cover said mechanisms in the stored position 200. For example, the side walls 120 may extend over the second set of slides 146 coupled between the cradle 106 and the pair of sliding supports 112, and the first set of slides 114 coupled between the pair of sliding supports 112 and the intermediate frame 150. The intermediate frame is coupled to each of the first longitudinal support 132 and the second longitudinal support 134 of the base frame 110. The straps 122 extend from the tray 118 to extend about the surface of the golf bag 106 and engage each other to secure the golf bag 106 to the tray 118.

For purposes of this disclosure, the term “coupled” (in all of its forms, couple, coupling, coupled, etc.) generally means the joining of two components directly or indirectly to one another. Such joining may be stationary in nature or movable in nature; may be achieved with the two components and any additional intermediate members being integrally formed as a single unitary body with one another or with the two components; and may be permanent in nature or may be removable or releasable in nature, unless otherwise stated.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. Furthermore, the terms “first,” “second,” and the like, as used herein do not denote any order, quantity, or importance, but rather are used to denote element from another.

Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. For example, the terms “approximately,” “about,” and “substantially” may refer to an amount that is within less than 5% of, within less than 1% of, within less than 0.1% of, and within less than 0.01% of a stated amount.

Further, it should be understood that any directions or reference frames in the preceding description are merely relative directions or movements. For example, the terms “upper,” “lower,” “right,” “left,” “rear,” “front,” “vertical,” “horizontal,” “inboard,” “outboard” and derivatives thereof shall relate to the orientation shown in FIG. 1. However, it is to be understood that various alternative orientations may be provided, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A vehicle storage and loading system comprising:
a base frame configured to rest in a vehicle cargo area;
a sliding support coupled to the base frame and configured to move between a stored position and an extended position relative the vehicle cargo area;
a cradle supported by the sliding support and configured to hold an object; and
a loading hinge attached between the cradle and the sliding support,
wherein, with the sliding support in the extended position, the cradle is configured to pivot about the loading hinge between a holding position and a loading position that is angled relative to the holding position.

2. The vehicle storage and loading system of claim 1, wherein the sliding support includes an elongated beam disposed between the base frame and the cradle.

3. The vehicle storage and loading system of claim 1, further comprising a slide mechanism at least partially disposed between the base frame and the sliding support, wherein the sliding support slidably moves on the slide mechanism from the stored position to the extended position.

4. The vehicle storage and loading system of claim 3, wherein the sliding support is vertically aligned with the base frame in the stored position and the sliding support is vertically offset from the base frame in the extended position.

5. The vehicle storage and loading system of claim 1, further comprising a first slide mechanism disposed between the base frame and the sliding support and a second slide mechanism disposed between the sliding support and the cradle, wherein the sliding support slidably moves on the first slide mechanism from the stored position to the extended position, and wherein the cradle slidably moves on the second slide mechanism from a second stored position to a second extended position with the cradle at least partially extending out of a rear end of the vehicle cargo area.

6. The vehicle storage and loading system of claim 1, wherein the sliding support is slidably coupled to an intermediate frame that is coupled to the base frame via a tipping hinge.

7. The vehicle storage and loading system of claim 6, wherein in the loading position, the tipping hinge is configured to pivot the intermediate frame upward from the base frame.

8. The vehicle storage and loading system of claim 1, further comprising a slide mechanism at least partially disposed between the sliding support and the cradle, wherein the cradle slidably moves on the slide mechanism between a second stored position and a second extended position.

9. The vehicle storage and loading system of claim 8, wherein the cradle is vertically aligned with the sliding support in the second stored position and the cradle is vertically offset from the sliding support in the second extended position.

10. The vehicle storage and loading system of claim 1, further comprising a folding arm coupled to the base frame and configured to attach to a connection feature on a sidewall of the vehicle cargo area, wherein the folding arm includes a stow hinge that is configured, with the sliding support in the stored position, to pivot the base frame about the stow hinge to a folded position adjacent to the sidewall of the vehicle cargo area.

11. The vehicle storage and loading system of claim 10, wherein the folding arm includes a first section coupled to the base frame and a second section extending perpendicular to the first section to attach to the connection feature.

12. The vehicle storage and loading system of claim 1, wherein the cradle includes a tray having a contoured surface configured to hold the object and side walls extending at least partially over the sliding support in the stored position.

13. The vehicle storage and loading system of claim 12, wherein the cradle includes a rigid platform that extends from a bottom portion of the tray to support the object with the cradle angled or upright in the loading position.

14. The vehicle storage and loading system of claim 12, wherein the cradle includes one or more straps extending across the contoured surface between opposing sides of the tray to retain the object in the cradle.

15. A vehicle storage and loading system comprising:
a base frame;
a pair of sliding supports slidably coupled to the base frame and configured to slide between a stored position and an extended position relative to the base frame;
a cradle supported by the pair of sliding supports and configured to hold an object; and
a pair of loading hinges attached between the cradle and the pair of sliding supports,
wherein, with the pair of sliding supports in the extended position, the cradle is configured to pivot about the pair of loading hinges between a holding position that is substantially parallel with the base frame and a loading position that is angled relative to the base frame.

16. The vehicle storage and loading system of claim 15, wherein the cradle is slidably coupled to the pair of sliding supports, and wherein the cradle is configured to slide from an intermediate stored position to a second extended position relative to the pair of sliding supports.

17. The vehicle storage and loading system of claim 16, wherein, with the pair of sliding supports in the extended position and the cradle in the intermediate stored position, the cradle is moved a first distance relative to the base frame, and wherein, with the pair of sliding supports in the extended position and the cradle in the second extending position, the cradle is moved a second distance relative to the base frame that is greater than the first distance.

18. The vehicle storage and loading system of claim 15, wherein the cradle includes a tray having a contoured surface configured to hold the object and side walls extending at least partially over the pair of sliding supports in the stored position.

19. The vehicle storage and loading system of claim 18, wherein the cradle includes a rigid platform that extends from a bottom portion of the tray to support the object with the cradle angled or upright in the loading position.

20. The vehicle storage and loading system of claim 15, further comprising a folding arm coupled to the base frame and configured to attach to a connection feature of a vehicle cargo area, wherein the folding arm includes a stow hinge that is configured, with the pair of sliding supports in the stored position, to pivot the base frame, the pair of sliding supports, and the cradle about the stow hinge to a stowed position.
